(19) United States
(12) Patent Application Publication
(10) Pub. No.: US 2017/0215385 A1
(43) Pub. Date: Aug. 3, 2017

(54) PET HARNESS WITH WASTE BAG DISPENSER AND STORAGE

(71) Applicants: Kyle Hansen, Castle Rock, CO (US); Michael Parness, Foxfield, CO (US)

(72) Inventors: Kyle Hansen, Castle Rock, CO (US); Michael Parness, Foxfield, CO (US)

(73) Assignee: The Kyjen Company, Inc., Centennial, CO (US)

(21) Appl. No.: 15/011,408

(22) Filed: Jan. 29, 2016

(51) Int. Cl. A01K 27/00

(52) U.S. Cl. CPC A01K 27/006; A01K 27/002; A01K 27/008

(57) ABSTRACT

The invention relates to a novel pet harness and pack for comfortably harnessing a dog and providing a dispenser for waste bags one on side of the harness and a storage pouch on the opposite side. The pouches are colorfully decorated with character faces and the bags will dispense out of a portion of the character's face. A metal loop is provided beneath a cross-stitched reinforced section of fabric wherein a leash may be attached to the harness.

### FIELD

The invention relates to a novel pet harness and pack for comfortably harnessing a dog and providing a dispenser for waste bags and a storage pocket. A metal loop is provided wherein a leash may be attached to the harness.

### BACKGROUND OF THE INVENTION

The invention most closely corresponds with USPTO Class 119/792/54 wherein Class 119 relates to animal husbandry, Class 792 includes tether and animal securing means, and sub-class 54 relates to harnesses.

In its simplest form, the invention relates to a novel harness which comfortably encircles a dog's belly and provides a decorative waste bag dispenser on one side and a storage pocket for small items on the other.

Waste bags are inserted into the dispenser which provides an aperture for dispensing bags one at a time similar to a tissue box dispenser. A similar pouch exists on the other side of the harness wherein a zippered pocket also provides storage for items the pet owner may wish to insert therein. This can include the used waste bags or items the pet owner wishes to keep separate from any waste related material.

### THE INVENTION

### SUMMARY, OBJECTS AND ADVANTAGES

For pet owners, picking up dog's waste isn't just a common courtesy, and in many states a legal requirement; it is a health imperative. Picking up after your dog helps reduce the likelihood of its fecal bacteria ending up in an increasingly contaminated water supply. Dog feces are common carriers of heartworms, whipworms, hookworms, roundworms, tapeworms, parvovirus, giardia, salmonella, and E. coli.

Many states or municipalities require a pet owner to pick up and remove pet waste. Obvious issues result in populace urban areas where grassy areas or other places a dog may need to go are scarce. Not picking up after a pet is simply unacceptable for health, legal, and common courtesy reasons.

There are a multitude of dog waste bags on the market, and even various dispensers. Most are bulky and cumbersome. Some pet waste bag dispensers are clipped to the pet's leash and dangle from it in some way. These dispensers are easily knocked off or require the pet owner to remove the leash to allow the pet to go so that the dispenser and leash do not come in contact with the dog's feces. Other waste bag dispensers require the pet owner to carry them in a pocket, handbag or the like. This is not convenient.

Quite often a pet owner may be walking a dog and there is no nearby trash receptacle. This lends itself to pet owners simply not picking up the waste since there is no convenient place to dispose of it. The inventive harness and waste bag dispenser is integrated into a comfortable harness from which the pet owner can attach a leash, and provides two pouches so that waste bags can be dispensed, but also stored until the pet owner is near a waste receptacle. When the pet needs to go to the bathroom, a bag is dispensed one at a time like a tissue, utilized, and easily discarded in a proper trash receptacle. On one side of the harness is the bag dispenser pouch, and on the other, a zippered storage pouch in which the pet owner can place small items or the used waste bag if they are not near a trash receptacle.

The harness does not need to be removed and is safely distanced from the dog's urine or feces so it does not become soiled or contaminated with harmful bacteria. The dispenser also contains a unique design in the form of a character wherein the bag might dispense from the eye of a pirate character, monkey, unicorn or owl.

### BRIEF DESCRIPTION OF THE DRAWINGS

The invention is described in further detail by reference to ten (10) drawings sufficient in detail to describe the invention in which:

FIG. 1 shows a dog wearing the harness and waste bag dispenser;

FIG. 2 is a top perspective of the harness and waste bag dispenser;

FIG. 3 an unadorned perspective of the harness and waste bag dispenser;

FIG. 4 is an example of the characters to be placed on the pouches of the harness and waste bag dispenser;

FIG. 5 is a side perspective of an adorned harness and waste bag dispenser on a dog;

FIG. 6 is a magnified cross section of the harness straps;

FIG. 7 is a magnified view of a reinforced strap section;

FIG. 8 is an illustration of a waste bag being dispensed from the eye of a character on a pouch;

FIG. 9 is a magnified view of a section of harness strap and material which joins the straps to the pouch portions; and

FIG. 10 is another perspective of a section of harness strap and material which joins the pouch portions as resides under the pouch portion.

### DETAILED DESCRIPTION, INCLUDING BEST MODES OF CARRYING OUT THE INVENTION

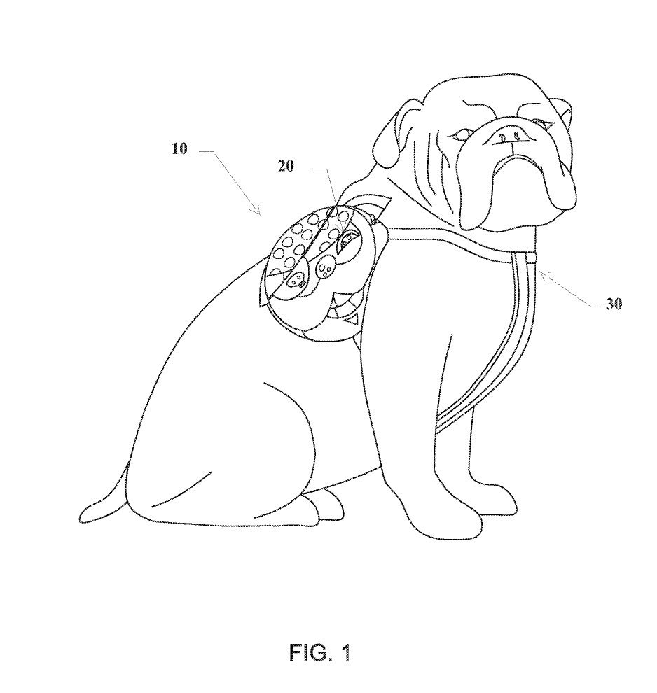

FIG. 1 illustrates a dog wearing an adorned harness and waste bag dispenser 10, wherein the character face provides bag dispensing from the eye of the character 20, and wherein the bags dispense one at a time as with a tissue from a box. The chest cross section of straps 30 are also illustrated in this Fig.

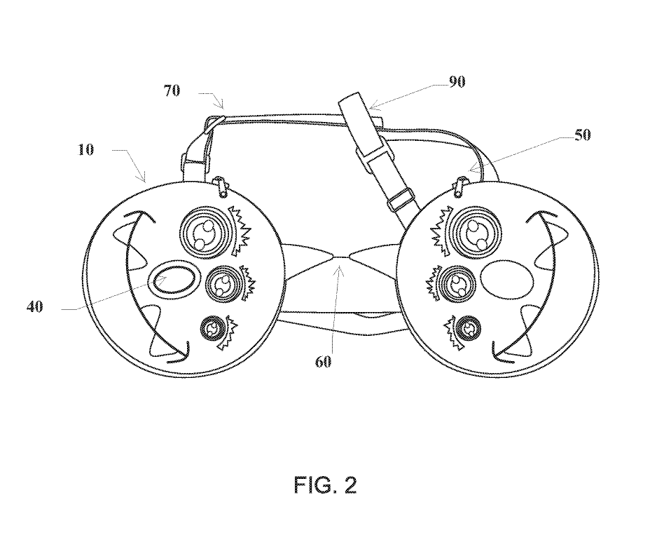

FIG. 2 illustrates the harness and waste bag dispenser as laid flat. The bag dispensing pouch 10 is shown as a character wherein the bags dispense in this case, from the character's nose section 40. A zippered storage pouch 50 mirrors the dispensing pouch wherein the pet owner can store small items or a filled waste bag for later disposal of the bagged pet waste. Fabric joins the two pouches 60 as would rest on the back of the dog. Reinforced nylon straps 70 fit around the belly of the dog and a similar reinforced strap 90 then runs down the chest of the dog for a comfortable fit.

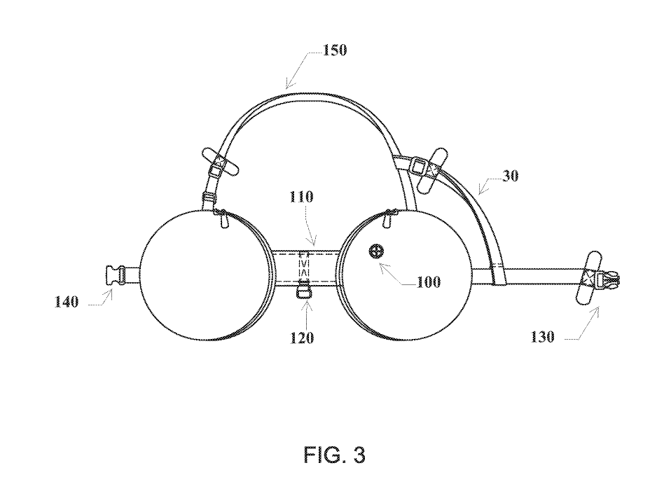

FIG. 3 is an unadorned view of the harness and waste bag dispenser illustrating a pouch with dispensing slot 100. In this embodiment, the center connection of the pouches 110 is wide with reinforced stitching, and contains a loop 120 for attaching a leash to the harness. A male buckle connector 130 is located on one end of the harness strap which then adjoins to a female connector 140 for comfortably attaching under the dog's belly section. The chest strap 30 is again illustrated here as will run down the dog's chest area and connect to the harness belly strap 150 and the pouch straps.

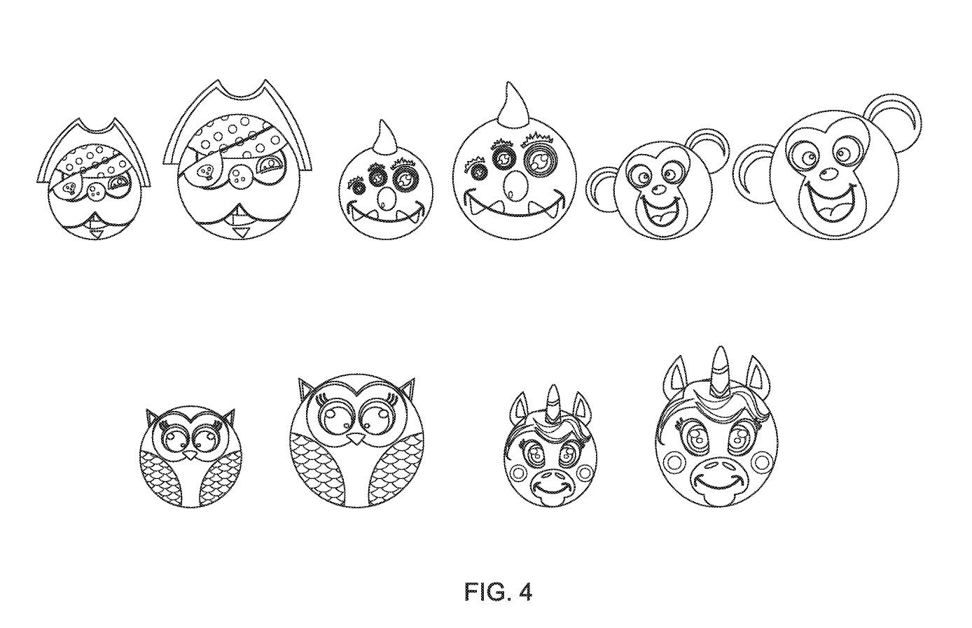

FIG. 4 is an example of the pouch characters, and as indicated, the waste bags can dispense from eyes, nose or other areas of the character's faces. Again, one pouch will contain waste bags and the other serve as storage.

FIG. 5 is another perspective of the harness and waste bag dispenser as worn by a dog with a character pouch 10 shown on one side. The chest strap 30 is again illustrated as connects to the belly strap 150 which then encircles the dog comfortably.

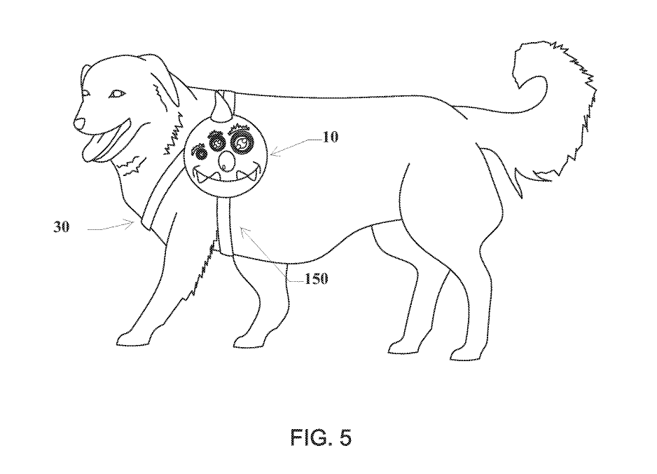

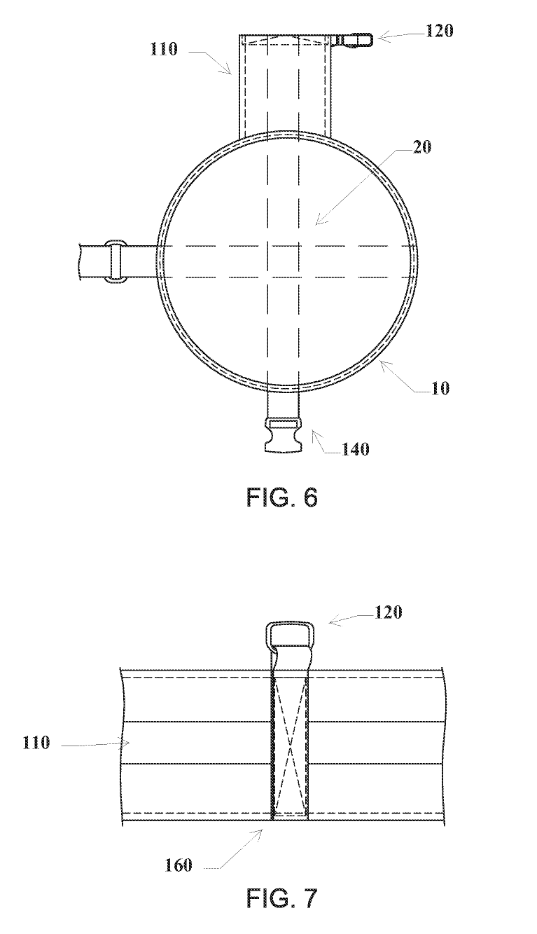

FIG. 6 is a view of the cross section 160 wherein the harness straps intersect underneath a character pouch 10. The material is double seamed for sturdiness yet wide enough so as not to dig into the dog's body. The wider belly strap 110 is again illustrated in this Fig. as it will encircle the dog and includes the female buckle portion 140 as well as means for attaching a leash to the harness 120.

FIG. 7 is a magnified view of the wide belly strap 110 and the loop 120 for attachment of a leash to the harness. In this embodiment a cross stitched reinforced section of fabric 160 adds strength to the means for attaching the leash loop to the harness straps.

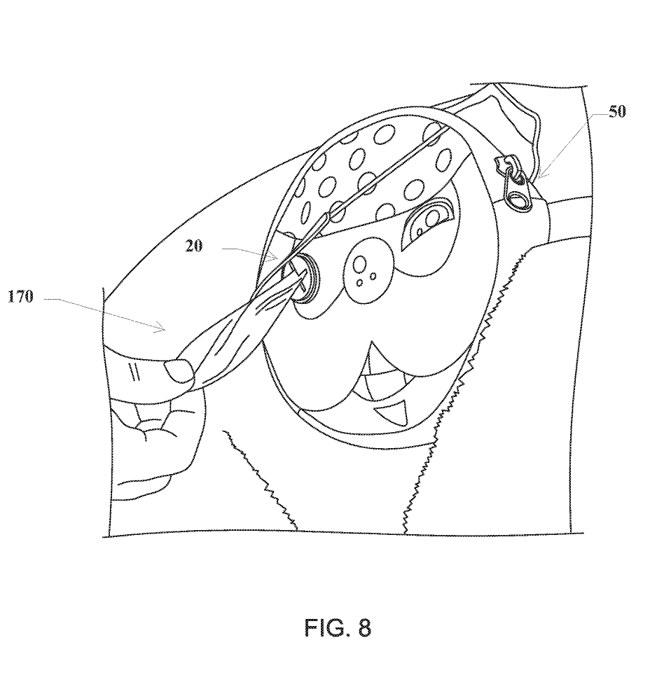

FIG. 8 demonstrates a pet owner pulling a waste bag 170 from the eye of a character 10 as will dispense one at a time. Again the zippered portion 50 of the pouch is shown to indicate where the pet owner will insert the waste bags for singular dispensing.

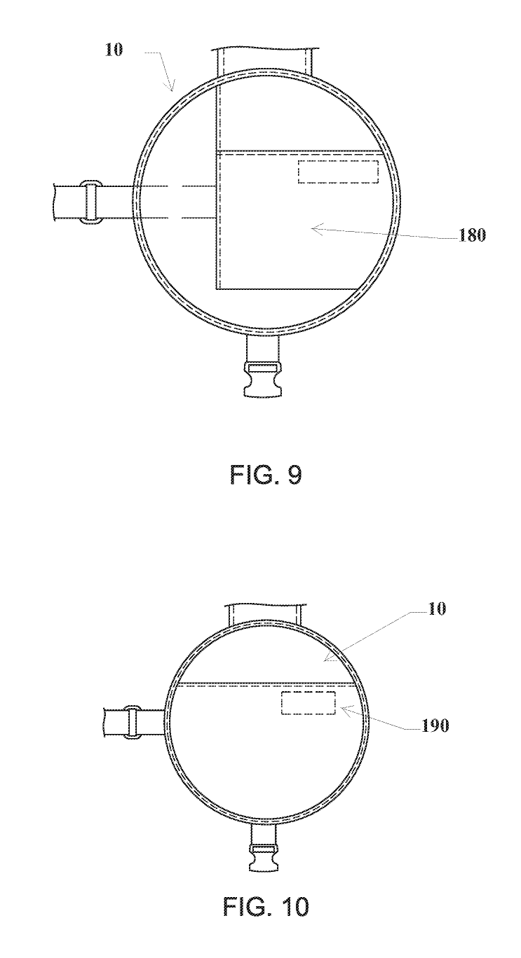

FIG. 9 illustrates another view of the reinforced cross section 180 as it resides under one of the pouches 10. The cross sections may vary as the character design dictates, but always seeks to be reinforced and double stitched for strength as well as designed for maximum comfort of the dog.

FIG. 10 is similar to that of FIG. 9 but shows the pouch 10 as exists atop the cross section shown in FIG. 9 which would typically not be in view. In this Fig. an example of where the waste bags will dispense 190 is provided for perspective on this unadorned pouch illustration.

1) A pet harness with waste bag dispenser and storage comprising:
a) At least three (3) reinforced straps for connecting two pouches and the harness around a pet
b) a zippered character based waste bag dispenser on one side of the harness
c) a zippered character based storage pouch on the opposite side of the harness
d) a male and female buckle clasp for connecting the reinforced straps
e) a metal loop for connecting a leash to the harness
f) a cross-stitched reinforced fabric panel for connecting the loop to the harness.

2) The pet harness with waste bag dispenser and storage as in claim 1 wherein a set of at least three (3) reinforced straps extend around the chest, belly and back of a pet and create a connection point along the back of the pet wherein the two pouches are also connected to reside on each side of the pet's body.

3) The pet harness with waste bag dispenser and storage as in claim 1 wherein a circular zippered pouch is affixed to the reinforced straps which receives pet waste bags and wherein a dispensing aperture on the pouch will dispense the bags one at a time from a portion of a character based design as in an animal face, pirate or similar decorative character.

4) The pet harness with waste bag dispenser and storage as in claim 1 wherein a zippered pouch is located on the opposite side of the harness from the bag dispensing pouch and provides storage for used waste bags or other pet related items, and wherein the pouch is a character design such as a pirate face, an animal face or similar decorative character.

5) The pet harness with waste bag dispenser and storage as in claim 1 wherein one of the reinforced straps contains a male and female buckle portion for connecting the harness around the pet's body.

6) The pet harness with waste bag dispenser and storage as in claim 1 wherein a circular metal loop is attached to the harness for affixing a pet leash thereto.

7) The pet harness with waste bag dispenser and storage as in claim 1 wherein a section of cross-stitched fabric is affixed atop a reinforced strap and connects the metal loop in a manner so as to prevent the loop from tearing off the straps when a leash is attached to the loop.
